(19) United States
(12) Patent Application Publication
(10) Pub. No.: US 2004/0028785 A1
(43) Pub. Date: Feb. 12, 2004

(54) Aroma dispenser

(76) Inventors: Sylvie Langourieux, New Milford, CT (US); Eugene Scoville, New Milford, CT (US); Randall C. Chrisman, Southbury, CT (US)

Correspondence Address: WINSTON & STRAWN, PATENT DEPARTMENT, 1400 L STREET, N.W., WASHINGTON, DC, 20005-3502, US

(21) Appl. No.: 10/214,274

(22) Filed: Aug. 6, 2002

(51) Int. Cl. A23F 3/00

(52) U.S. Cl. 426/386

(57) ABSTRACT

The present invention relates to an aroma dispensing device that includes a first storage container for storing an aroma containing solvent, an extraction column for extracting the aroma from the solvent to substantially remove aroma from the solvent and for dispensing the aroma out of the dispensing device, and a second storage container to salvage the solvent when depleted in aroma after extraction by the extraction column. It also relates to a process for dispensing aromas by extracting an aroma from a supply of a fluid, non-volatile solvent for use in aromatizing one or more or a food-forming or beverage forming ingredient or a food or beverage product, thus forming an aroma-depleted solvent; and salvaging the aroma-depleted solvent for re-use as a carrier of further aroma(s).

### FIELD OF THE INVENTION

The present invention relates to an apparatus dedicated to dispense aromas, and to a process for dispensing aromas.

### BACKGROUND OF THE INVENTION

Aroma dispensers and air fresheners are known in the prior art. For example, U.S. Pat. No. 6,029,901 relates to an air freshener dispenser comprising a housing having a hole, a porous bladder adapted for holding a scented liquid, the housing having a plurality of spaced apart vent slits to permit the passage of the aroma. This apparatus presents the disadvantage that all the aroma is released very rapidly, and also that the quantity of the aroma delivered is not controlled.

British patent application GB 2358587 discloses an aroma dispenser that allows an aroma to be carried by air circulated by a heater. The aroma dispenser comprises a layer of absorbent for a volatizable aromatic substance placed between a pair of parallel plates, and a central boss located on one of the plates, preventing compression of the absorbent layer and engaging with a threaded projection. This system traps the absorbent layer between plates so that the absorbent layer is closely adjacent, and in contact with at least one plate, the emission of vapour is constrained to take place through the peripheral edge of the absorbent. This is an attempt to control the emission of aromas, but this system is not easy to use as being messy when the absorbent has to be changed, and still presents the problems of convector heaters, which gives an impression of stale air.

British patent application GB 2253733 concerns a display apparatus for displaying advertising posters and further comprising an aroma dispenser and/or an audio playback system. The aroma concentrate, for example a coffee aroma concentrate, is released intermittently in fine spray form into the atmosphere, using atomising heads. The aroma concentrate is replenished by removing a concentrate bottle, unscrewing the atomising head before pouring the refill down the neck of the concentrate bottle. The aroma displaying system is a spraying system, which is inconvenient when the aroma is in an oil solvent. Furthermore, it is messy and difficult to refill.

U.S. patent application Ser. No. 2001/0012495 relates to dispensers for active materials employing heat conductive elements to distribute heat from a burning flame at a wick to a simmer plate and to the body of a solid fuel containing the active material, so as to more rapidly liquefy the solid fuel and to more uniformly and intensely heat such fuel to volatilise the active material. The fuel may be paraffin wax and may contain fragrances, air fresheners, odor interactants, herbal and medicinal substances, among others. The dispenser is quite simple and easy to handle, but the aromas can be damaged or ruined by being heated and can suffer from being in close contact with a fuel.

German patent application DE 29708840 discloses a perfume-dispensing equipment in metered quantities. A vaporizing dish is contained in a housing, with etherical materials being drip-fed to it with the quantity and timing of the drip-feed being regulated by a controller unit. The latter also regulates a pump delivering from one or more interchangeable storage bottles. Each bottle can be sealed by a membrane which can be punctured by a needle. Two needles with side slots can be mounted in the end face of the bottle mounting. The vaporizing dish can be interchanged. An insert in the housing can have a rotary regulator for the drip frequency, and this also actuates a ventilation system.

As can be understood, different approaches have been tempted to obtain a satisfactory aroma dispenser. Different techniques, listed in the above-mentioned patents or patent applications, have been used, but all have disadvantages. One common disadvantage lies in the filling of the device with the aroma, which is usually an uneasy and messy procedure. Another disadvantage relates to the release of oil based components that can soil the place where the aroma is dispensed. Another disadvantage relates to the inconsistent intensity and/or discontinuous release of aroma according to such known techniques.

Thus, there is a need for improved aroma dispensing devices or system and the present invention is intended to satisfy this need by providing such devices, systems and processes that avoid the problems of the prior art.

### SUMMARY OF THE INVENTION

The present invention relates to an aroma dispensing device comprising first storage means for storing an aroma containing solvent, extraction means for extracting the aroma from the solvent to substantially remove aroma from the solvent and for dispensing the aroma out of the dispensing device, and second storage means to salvage the solvent when depleted in aroma after extraction by the extraction means. Advantageously, the solvent is non-volatile and is enriched with the aroma.

Preferably, the aroma is a food- or beverage-related aroma and the first storage means is a flexible container that is capable of retaining a first volume. Also, the second storage means is a flexible container that has a volume that is approximately the same as that of the first storage means.

Advantageously, the extracting means is a stripping column, and preferably one that includes a gas that flows in a current that is inverse to that of the solvent. Also, the extracting means is operatively associated with at least one pumping means, such as one that includes a first head portion that directs the aroma containing solvent out of the dispenser and a second head portion that returns the salvaged solvent into the second storage means, or one that includes a liquid pumping means and a gas pumping means, wherein the liquid pumping means transports the solvent containing aroma to an upper portion of the extracting means, while the gas pumping means delivers gas into a lower portion of the extracting means. In a preferred embodiment, the gas pumping means is an air pump that is in fluid communication with connected a lower end of the extracting means, while the liquid pumping means is a pump that is in fluid association with the upper end of the extracting means.

The invention also relates to a process for dispensing aromas which comprises extracting an aroma from a supply of a fluid, non-volatile solvent for use in aromatizing one or more or a food-forming or beverage forming ingredient or a food or beverage product, thus forming an aroma-depleted solvent; and salvaging the aroma-depleted solvent for re-use as a carrier of further aroma(s). Preferably, the aroma is extracted from the fluid, non-volatile solvent by applying an inverse current of a stripping gas, such as by directing the aroma-containing solvent into an upper portion of an extraction zone while directing the gas into a lower portion of the extraction zone, such that the gas moves toward the upper portion of the zone while the solvent moves toward the lower portion of the zone, thus causing the aroma to be stripped from the fluid, non-volatile solvent. The solvent generally has a flow rate of between about 0.25 to 2 g/min, and the gas has a flow rate of between about 1 and 10 L/min.

The invention also relates to an improvement in a method wherein an aroma is provided from a fluid, non-volatile solvent that contains the same and is prepared for addition to or incorporation in a food-forming or beverage-forming ingredient or a food or beverage product. This improvement which comprises salvaging the solvent after depletion of the aroma for re-use as a carrier for further aroma(s). The method includes the steps of re-filling a flexible container with the salvaged solvent and an aroma for re-use in an aroma dispenser, and the aroma is extracted from a supply of a fluid, non-volatile solvent for use in aromatizing the food-forming or beverage forming ingredient or food or beverage product, thus forming the aroma-depleted solvent.

### BRIEF DESCRIPTION OF THE DRAWINGS

Preferred features of the invention are observable in connection with the appended drawing FIGURE, which is a schematic view of the aroma dispenser according to the invention.

### DETAILED DESCRIPTION OF THE INVENTION

The present invention generally relates to an aroma dispenser that also salvages a carrier solvent after it has delivered the aroma, and an extracting means that in the most preferred embodiment is a stripping column. The invention also relates to a process for dispensing aromas, characterized by a salvage of the aroma carrying solvent after depletion of the aroma for recycling and re-use.

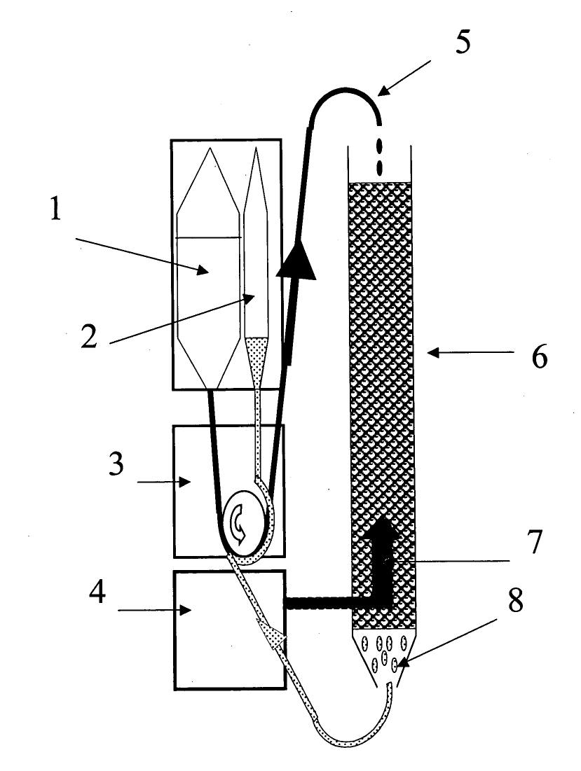

Referring to FIG. 1, the dispenser includes the supply container 1 and the waste container 2. A liquid pump 3, preferably a dual peristaltic pump, is used to direct the aroma containing solvent into stripping column 6, while a gas pump 4 is used to direct a stripping gas, such as air, into the stripping column at 7. Aroma-depleted solvent 8 is collected at the bottom of the stripping column and is directed to waster container 2.

This invention provides three improvements over the prior art. These features can be used alone or in combination, as desired by the skilled artisan when designing the device for an intended application.

The first characteristic lies in the ability of the device to salvage the carrier solvent after it has delivered and become depleted of the aroma. For that, the apparatus comprises two or more containers, with at least one being a supply container 1 for containing a solvent combined with aroma(s) and at least one being a waste container 2 for containing the salvaged solvent after extraction of the aroma(s) and containing, at most, very small amounts of residual aroma. Preferably, these containers 1,2 have the same volume, but volumes can also be different as long as the volume of the waste container is at least equal to the volume of the supply container.

The solvent is preferably a non-aqueous and non-volatile liquid, and is in a most preferred embodiment an oil. It can also be water, among other liquids. For coffee applications, for example, the aromatized substrate is suitably a coffee oil or an emulsion of coffee oil and water or coffee extract. In this embodiment, it is preferred that the coffee oil contain as little moisture as possible; for example less than 4% moisture by weight. The coffee oil which is used may be any desirable coffee oil; it can be for example coffee oil obtained from commercial sources or produced by extracting it from spent coffee grounds and the like using procedures which are well known in the art. For example, the coffee oil may be expelled from freshly roasted coffee beans using commercially available oil expellers. This technique and other suitable techniques for extracting coffee oil from coffee beans are described in the text entitled “Coffee Technology” by M. Sivetz et al., AVI Publishing Co., Inc., Westport, Conn. (1979), pages 452 to 460. The source and the exact composition of the coffee oil used are not critical. Other oils may be used in full or partial replacement of coffee oil.

For coffee applications, the aroma carried by the substrate is preferably coffee aroma. Conveniently, coffee aroma is made up of natural coffee aroma gases. The coffee aroma gases may be collected at any of several points in the processing of coffee, for example gases evolved during roasting of green coffee (“roaster gases”), gases evolved during grinding of roasted whole beans (“grinder gases”) and those evolved during infusion of ground roasted coffee (“infusion gases”).

In another embodiment, it is possible to use an oil enriched with coffee aroma as disclosed in U.S. Pat. No. 5,342,638. The process disclosed therein comprises transferring coffee aromas to an oil by transporting a condensation product frost of carbon dioxide charged with coffee aromas and water into a heat-regulated enclosure having a lower part for containing an oil bath and having an upper part for containing the frost and for venting sublimed carbon dioxide; regulating a temperature of the oil bath at a temperature above a freezing point of the oil and regulating a temperature in the enclosure above the oil bath so that during introduction of the frost into the enclosure, a layer of frost is formed and maintained above the bath, carbon dioxide of the frost is sublimated and water of the frost is melted; venting carbon dioxide sublimated from the frost from the enclosure upper part, removing aroma- and water-laden oil bath from the enclosure lower part, and adding oil to the bath to replace the oil removed from the enclosure, while introducing frost into the enclosure and regulating the temperatures; and separating the bath removed from the enclosure to obtain separated aroma-laden oil and aroma-laden water components. The entire content of this patent is expressly incorporated herein by reference thereto.

Preferably, the aroma is a food or beverage related aroma. The aroma may either be a natural aroma or synthetic aroma, or a combination thereof. For example, the aroma can be chosen among the group consisting of vanilla, almond, chocolate, whisky, brandy, Irish cream, bread, pastries, mushrooms, candies, liquorice, nougat, grenadine, mint, peppermint, spices as well as fruit aromas such as cherry, raspberry, strawberry, pineapple, blackcurrant, or even maple syrup aromas, cooked meat aromas, and combinations thereof.

The containers are preferably removable flexible containers, such as pouches which are made of a plastic film or films and the like. These pouches can be equipped with connection means of the fitment type. The connection means typically comprise a snap fitment that complementarily engages connection means of the receiving member of the dispenser, e.g., a portion of hose. The connection means of the pouches and dispensers are of a complementary male-female type with latch means to allow a quick, secure and reliable interconnection. The fitment of the pouch may further comprise closing means, such as a plug engaging a seat, for closing off the bore of the fitment. Therefore, the pouches can conveniently and quickly be plugged to the dispenser by the operator. The closing means of the fitment also allows reclosing of the pouch once removed, so that the waste pouch does not leak and no precaution has to be taken by the user when removing the pouch. Suitable examples of such connection means are the fitment system “CLEANCLIC®” which is commercialized by I.P.N. Company of the Netherlands.

The fact that the carrier solvent is salvaged presents several advantages, including beneficial effects on the environment because it avoids release of the solvent in the atmosphere during dispensing. It also allows proper disposal of oil, and reduced costs because the used oil located in the “waste” pouch can be remixed with aroma. Furthermore, another advantage can be seen in the fact that changing the bags can be achieved in a very clean way by changing an empty or almost empty supply pouch by a new and full supply pouch, and by changing a full “waste pouch” by a new and empty one.

The second characteristic lies in the extracting means 6 of the aroma from the solvent. According to an aspect of the invention, the extraction is carried out by a gas 7 that extracts aroma from the oil. The extraction is preferably carried out by contacting aroma containing oil as a film, droplets, spray or combinations thereof with a current of gas. As a result of the gas contacting the aroma containing oil, the volatile aroma compounds are captured by the current of gas while the oil molecules, which are not vaporizable in volatile compounds, are not. These volatile aroma compounds are then released in suspension in the gas out of the dispenser.

For that, the extracting means preferably comprises a stripping column 6 that allows intimate contact of the gas and oil. In a preferred embodiment, the column may be made of a hollow plastic member that contains mixing elements allowing the oil to make a falling film, and thus optimizing the contact between oil and gas. Such mixing elements may be, for example, in-line static mixers, packing or other flow mixing devices such as marbles.

Preferably, the gas is an extracting gas that can be safely and economically released in the atmosphere. Air is the preferred gas, and as the oil is running downwardly through the column, the aroma is more and more extracted by the air flow depending upon flow rates and the length of the column. One of ordinary skill in the art can select the optimum parameters by routine testing.

The liquid film should not be too thick in order to perform a good aroma extraction. Accordingly, an optimal value has to be found between parameters such as the column length, its diameter, the elements inside the column that slow down the liquid, and flows of air and oil. The column can be, for example, an in-line static mixer.

Of course, the extracting means is not limited to a stripping column and can be any other suitable means allowing to extract the aromas from the solvent, such as bubbling of air into a reservoir that contains the aroma enriched solvent or oil.

In the third characteristic of the invention, the extracting means is connected to pumping means. Preferably, at least two pumping means are used; i.e., a liquid pumping means 3 and a gas pumping means 4. When a vertical stripping column 6 is used, the liquid pumping means advantageously transports the solvent containing aroma 5 to the top of the extracting means where the liquid is released and falls by gravity therethrough, while the gas pumping means delivers gas into the bottom of the extracting means where it can pass upwardly therethrough to the top. The liquid pumping means 3 can be further arranged to collect the waste oil 8 from the bottom of the extracting means and direct it to the waste container. For example, the liquid pump can be a two-head pump, where one head pushes the supply liquid into the extracting means and the other head urges the salvaged solvent into the waste pouch. This can also be achieved by using two different or separate pumps, one for pushing the solvent containing aromas into the extracting means and one for pushing the salvaged solvent into the waste pouch.

When the extracting mean is a column, for example, the air pump connected to the bottom of the column allows a rising air current and the liquid pump connected to the top of the column allows the liquid to go down the column, either by gravity or more rapidly by pumping pressure. The combination of these two pumps allows a countercurrent flow which facilitates the extraction of the volatile aroma from the solvent, for example a liquid fat phase. Consequently, the air leaving the column comprises the volatile aroma molecules which can them be directed into a final food or beverage product.

The air pump can be any type of air pump available; however, it does not have to be a pump that has a high flow nor with a very controlled flow, as slow variations of the airflow do not significantly modify the quality of the extraction and the intensity of the aroma release. The air pump can be replaced by any equivalent means known by the skilled person, such as a fan, blower or other air circulation device.

The liquid pump can be any type of pump capable of pushing liquids; it can be for example a peristaltic pump, a pump with pistons or a diaphragm pump compatible with oil phases. Preferably, the pump pushing the liquid comprises a flow rate control means enabling to regulate the liquid flow rate on request.

This air pump and liquid pump system achieves many advantages. First of all, the extracting means can be supplied continuously or intermittently; preferably, the extracting means is continuously fed in order to have a constant aroma released. Also, the fact that the liquid solvent is pumped allows a precise regulation of the liquid flow, and consequently a regulated concentration of aroma in the air. Of course, if the third characteristic of the invention is not necessary, a drop to drop system is also suitable.

The typical oil flow rates can be from 0.25 to 2 g/min, preferably of from 0.35 to 1.0 g/min, even more preferably of at least about 0.5 g/min, while typical airflow rates can range from about 1 to 10 L/min, preferably of from 1.5 to 5 L/min, even more preferably of at least about 2 L/min.

According to another aspect of the invention, there is provided a process for dispensing aromas. The process comprises the steps of extracting the aromas from a fluid fat phase, namely a solvent. Preferably, the extraction is achieved by way of inversed currents of solvent and a gas, preferably air, in an extracting means which can comprise a stripping column. Accordingly, the extraction is a gas-oil extraction, preferably air-oil extraction. Another step of the process lies in salvaging the solvent after aromas have been extracted. In a preferred embodiment, inverse currents are created by means of pumps connected to each end of the extracting means. For example, an air pump can be connected to the bottom of the extracting means and another pump can be connected to the top of the extracting means, this second pump being able to push liquids, namely the fat phase solvent.

Another aspect of the process according to the invention lies in the refilling with aroma of the depleted solvent which has gone through at least one extraction. Accordingly aromas are blended together with the salvaged oil until an homogenous mixture is obtained. When the aroma contains water, some water can remain in the salvaged oil and if it is necessary to remove it, this can be accomplished by a decanting step.

The dispenser of the invention may serve to dispense food or beverage related aroma in foodservice areas such as restaurants, catering, convenient stores, bakery, kitchens and other commercial establishments. The dispenser may also be mounted to dispense aroma in foodservice devices such as vending machines and the like.

### EXAMPLES

The following examples are illustrative of some of the products and methods of making the same falling within the scope of the present invention. They are not to be considered in any way limitative of the invention. Changes and modifications can be made with respect to the invention. That is, the skilled person will recognise many variations in these examples to cover a wide range of formulas, ingredients, processing, and mixtures to rationally adjust the naturally occurring levels of the compounds of the invention for a variety of applications.

### Example 1

### Range of Flows Used and Effect on Aroma Concentration Delivered

An apparatus is built including the three aspects (characteristics) of the invention. Oil flows and airflows are modified to find the best performance of aroma extraction. Volatile organic compounds (VOC) are measured on the top of the extracting mean which is here a stripping column.

| | | VOC on top | |
|---|---|---|---|
| Oil flow | Air flow | of the column | Extraction |
| (g/min) | (g/min) | (mg/min) | efficiency (%) |
| 0.92 | 4.78 | 1.14 | 54 |
| 0.92 | 2.50 | 1.88 | 62.8 |
| 0.46 | 5.10 | 1.39 | 73.5 |
| 0.46 | 2.55 | 1.43 | 69.6 |
| 0.23 | 5.01 | 1.18 | 82.1 |
| 0.23 | 2.83 | 0.94 | 89 |

### Example 2

### Preparation of Aromatized Oil With Coffee Aroma

The aroma containing oil is prepared according to the following method. 1034 g/h frost are introduced into an enclosure from 300 kg/h roasted coffee. The frost contain 85.5% carbon dioxide, 12.6% ice and 1.9% aromas. Accordingly, the aromas are introduced into the enclosure at a rate of 19.6 g/h. A 17 cm deep layer of frost is formed, the temperature of the frost during sublimation being −78.5° C. and the average residence time 54 minutes.

The oil bath (formed by an emulsion of oil and water) has a volume of 0.8 liter and a temperature of 30° C. with an average residence time of the oil of 34 minutes, the oil supply rate being 1.275 kg/h.

The oil-water emulsion was removed at a rate of 1.424 kg/h with an aroma output of 19 g/h. The water content of the emulsion was 9.1%. 95% of the aromas present in the frost are thus recovered in the emulsion by means of this process.

### Example 3

### Composition of the Liquid Contained by the Supply Pouch, When Aromas Are Bakery Aromas

Aroma solution:

A breadcrust aroma is prepared as follows: in one liter ethanol are added, to make solution 1:

50 g 2-acetyl pyrazine

10 g 2-acetyl thiazole

30 g diacetyl

5 g 2-ethyl-3-methyl pyrazine.

0.1 g of this composition is added to 1 liter water salted beforehand with 3 g NaCl per litre to make solution 2. 1.0 mL of an aqueous solution containing 50 g/l 2-carbomethoxy-1-pyrroline is added to solution 2.

The delivered aroma has strong notes of the “cereal” and “breadcrust” type and a rounded “grilled” note.

What is claimed is:

1. An aroma dispensing device comprising:
first storage means for storing an aroma containing solvent,
extraction means for extracting the aroma from the solvent to substantially remove aroma from the solvent and for dispensing the aroma out of the dispensing device, and
second storage means to salvage the solvent when depleted in aroma after extraction by the extraction means.

2. The aroma dispenser according to claim 1, wherein the solvent is non-volatile and is enriched with the aroma.

3. The aroma dispenser according to claim 1, wherein the aroma is a food- or beverage-related aroma and the first storage means is a flexible container that is capable of retaining a first volume.

4. The aroma dispenser according to claim 3, where the second storage means is a flexible container that has a volume that is approximately the same as that of the first storage means.

5. The aroma dispenser according to claim 1, wherein the extracting means is a stripping column.

6. The aroma dispenser according to claim 5, wherein the stripping column includes a gas that flows in a current that is inverse to that of the solvent.

7. The aroma dispenser according to claim 1, wherein the extracting means is operatively associated with at least one pumping means.

8. The aroma dispenser according to claim 7, wherein the pumping means includes a first head portion that directs the aroma containing solvent out of the dispenser and a second head portion that returns the salvaged solvent into the second storage means.

9. The aroma dispenser according to claim 7 wherein the pumping means includes a liquid pumping means and a gas pumping means, wherein the liquid pumping means transports the solvent containing aroma to an upper portion of the extracting means, while the gas pumping means delivers gas into a lower portion of the extracting means.

10. The aroma dispenser according to claim 9, wherein the gas pumping means is an air pump that is in fluid communication with connected a lower end of the extracting means.

11. The aroma dispenser according to claim 9, wherein the liquid pumping means is a pump that is in fluid association with the upper end of the extracting means.

12. A process for dispensing aromas which comprises:
extracting an aroma from a supply of a fluid, non-volatile solvent for use in aromatizing one or more or a food-forming or beverage forming ingredient or a food or beverage product, thus forming an aroma-depleted solvent; and
salvaging the aroma-depleted solvent for re-use as a carrier of further aroma(s).

13. The process according to claim 12, wherein the aroma is extracted from the fluid, non-volatile solvent by applying an inverse current of a stripping gas.

14. The process according to claim 13, wherein the inverse current is created by directing the aroma-containing solvent into an upper portion of an extraction zone while directing the gas into a lower portion of the extraction zone, such that the gas moves toward the upper portion of the zone while the solvent moves toward the lower portion of the zone, thus causing the aroma to be stripped from the fluid, non-volatile solvent.

15. The process according to claim 12, wherein the solvent has a flow rate of between about 0.25 to 2 g/min, and the gas has a flow rate of between about 1 and 10 L/min.

16. In a method wherein an aroma is provided from a fluid, non-volatile solvent that contains the same and is prepared for addition to or incorporation in a food-forming or beverage-forming ingredient or a food or beverage product, the improvement comprising salvaging the solvent after depletion of the aroma for re-use as a carrier for further aroma(s).

17. The method according to claim 16, which further comprises re-filling a flexible container with the salvaged solvent and an aroma for re-use in an aroma dispenser.

18. The method of claim 17 wherein the aroma is extracted from a supply of a fluid, non-volatile solvent for use in aromatizing the food-forming or beverage forming ingredient or food or beverage product, thus forming the aroma-depleted solvent.
